(19) United States
(12) Patent Application Publication
(10) Pub. No.: US 2002/0076542 A1
(43) Pub. Date: Jun. 20, 2002

(54) ePTFE product for medical applications

(76) Inventors: Valentin Kramer, Feldkirchen-Westerham (DE); Bruce G. Ruefer, Bozeman, MT (US)

Correspondence Address: HAYNES AND BOONE, LLP, 901 MAIN STREET, SUITE 3100, DALLAS, TX, 75202, US

(21) Appl. No.: 10/017,798

(22) Filed: Dec. 12, 2001

(30) Foreign Application Priority Data
Dec. 13, 2000 (DE) 100 61 936.3

(51) Int. Cl. B32B 3/00; B32B 3/26; B29D 22/00; B29D 23/00; B32B 1/08

(52) U.S. Cl. 428/315.5; 428/36.5; 264/45.9

(57) ABSTRACT

The invention described herein consists of an expanded PTFE (ePTFE) material that contains a novel fibril and node structure that exhibits a pore size distribution of two or more distinct pore sizes. The pore size distribution of small pores inter-spaced with larger pores to create a mosaic pore structure is advantageous as a blood-contacting surface and renders the invention a very useful and advantageous vascular graft.

### FIELD OF THE INVENTION

The present invention relates generally to composite articles formed from expanded polytetrafluoroethylene (“ePTFE”) materials, and particularly to a composite article made up of a plurality of polytetrafluoroethylene (“PTFE”) components having differing expansion characteristics such that differing ePTFE structures are exhibited.

### BACKGROUND OF THE INVENTION

DE 690 03 879 describes a porous, at least uni-axially expanded PTFE material comprising a mixture of a PTFE having a high molecular weight of 2.000.000 or more and a PTFE having a low molecular weight of 1.000.000 or less. The size of the pores of the PTFE-material can be varied by changing the mixing ratio for the PTFE with high molecular weight and the PTFE with low molecular weight. The PTFE-material can exhibit different shapes, for example a foil, sheet or cube. Further, the PTFE-material can be used in different fields, for example as membrane filter exhibiting a low pressure loss as diaphragms, as smearing glide means and as bonding or sticking means, respectively.

Many similar designs of ePTFE tubes serving as vascular grafts (“grafts”) can be found in the market place. These designs range from a fairly simple uniaxially expanded ePTFE graft made into various bore sizes (W. L. Gore & Associates, Flagstaff, Ariz.) and lengths to more complex design of uniaxially expanded ePTFE tube reinforced with a ring complex made of fluorinated ethylene propylene (“FEP”) or ePTFE film (W. L. Gore & Associates, Flagstaff, Ariz.). In addition, double wall ePTFE grafts constructed as a “tube within a tube” can be found in the patent literature (U.S. Pat. No. 5,935,667). Most of these grafts are designed to exhibit a uniform structure of fibrils and nodes containing about 30 micron pores. This pore size is believed to be advantageous for blood contact, control bleeding, and make the graft adequately strong.

While the ePTFE vascular grafts are reported to be functional for their intended use, significant and novel design improvements are needed to address the known inadequacies of their designs that relate to optimum blood contact requirements, strength requirements, and pore size distribution. The invention disclosed herein accomplishes this goal.

### BRIEF DISCUSSION OF THE INVENTION

The invention described herein consists of an expanded PTFE (ePTFE) material that contains a novel fibril and node structure that exhibits a pore size distribution of two or more distinct pore sizes. The pore size distribution of small pores inter-spaced with larger pores to create a mosaic pore structure is advantageous as a blood-contacting surface and renders the invention a very useful and advantageous vascular graft, cardio vascular patch, cardio vascular suture, stent cover, and comparable medical devices and means.

The preferred invention disclosed herein consists of an ePTFE tube comprising two or more PTFE (polytetrafluoroethylene) resins that are blended, stretched, and sintered or locked into a novel fibril and node matrix. The tube is constructed to exhibit pores within the matrix of fibrils and nodes that exhibit two or more distinct size-distributions of pores. The preferred invention may be reinforced with an outer wrapping of a Fluorinated Ethylene Propylene (FEP) filament configured into a double helix structure. The advantages of the preferred invention will come forth as the details are disclosed herein.

According to a most preferred embodiment of the invention, there are provided at least two distinct groups of pores in the ePTFE (expanded polytetrafluoroethylene). A first group consists of pores the sizes of which are in, and preferably cover, the range of 2 micron to 15 micron, preferably in the range from 3 micron to 8 micron, most preferably in the range from 4 micron to 6 micron, in particular around 5 micron. A second group consists of pores having sizes which are in, and preferably cover, the range from 20 micron to 50 micron, in particular in the range from 25 to 40 micron, most preferably the range from 25 to 35 micron, in particular around 30 micron.

The afore-mentioned at least two distinct groups of pores are preferably randomly distributed in the ePTFE tube material. The smaller pores are found within the larger pores, according to a statistical (random) distribution of pores.

As to the number of pores of smaller size as compared to the number of pores of larger size, the afore-mentioned preferred embodiment comprising at least two distinct groups of pores, the invention discloses a ratio of number of pores per volume unit of expanded PTFE of the first group and the number of pores per volume unit of expanded PTFE of the second group, said ratio being selected in the range from 0,2 to 5, preferably 0,4 to 3, most preferably in the range of 0,6 to 2, in particular the ratio can have a value of 1+0,2.

The afore-mentioned embodiment of the invention comprising at least two distinct groups, and preferably two distinct groups, has turned out to be most efficient with regard to the above stated problem.

The invention also discloses a second embodiment of ePTFE tubes, also serving in particular as vascular grafts, cardio vascular patches, cardio vascular sutures, stent covers, and comparable medical devices and means said second embodiment being characterized in that all pores have sizes distributed in the range from 2 micron to 50 micron, preferably in the range from 4 micron to 40 micron, most preferably in the range from 5 micron to 30 micron. That distribution can be homogeneous in the stated range or it can be in accordance with a statistical distribution, like a Gaussian curve.

The preferred invention may be constructed in a variety of shapes and sizes, with or without the reinforcing wrapping as specific needs dictates.

### BRIEF DESCRIPTION OF THE DRAWINGS

FIG. 1 is a two-dimensional drawing showing the ePTFE tube with outer reinforcing wrapping of the preferred invention.

FIG. 2 a two-dimensional drawing showing the novel bi-pore mosaic structure of the preferred invention.

FIG. 3 is a 500× scanning electron micrograph (SEM) of the novel bi-pore mosaic ePTFE structure of the preferred invention.

FIG. 4 is a 100× scanning electron micrograph (SEM) of the novel bi-pore mosaic ePTFE structure of the preferred invention.

### DETAILED DESCRIPTION OF THE DRAWINGS

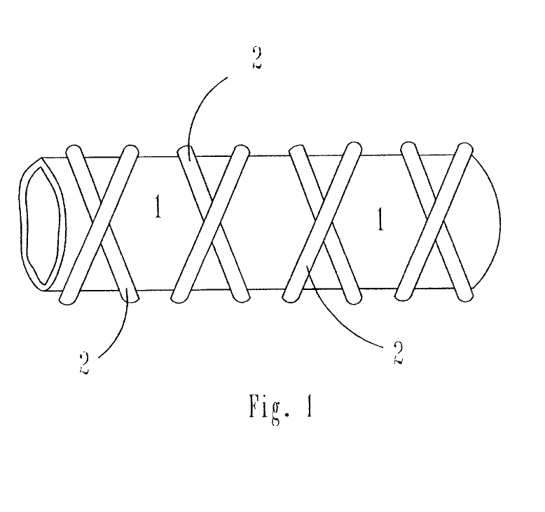

FIG. 1 depicts a two-dimensional overview drawing of the preferred invention showing the novel ePTFE tube 1 with a FEP filament wrap 2 reinforcing the tube.

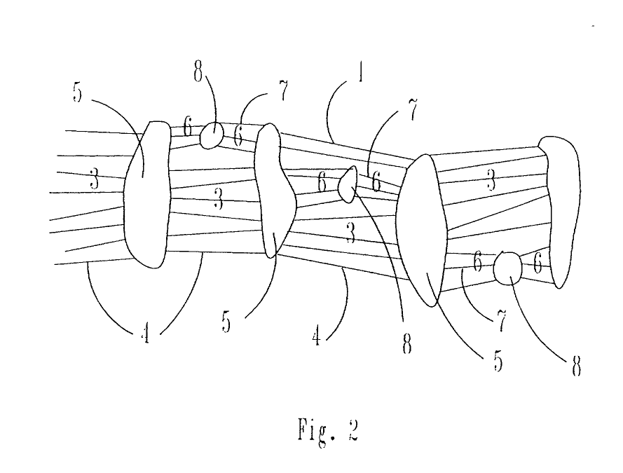

FIG. 2 shows a close up two-dimensional drawing of the preferred invention showing two distinct pore size distributions. The larger pores 3 are shown as a distribution within the structure and contain long fibril structures 4 connected between large solid PTFE node structures 5. The small pores 6 are shown as a distribution within the larger pores 3 and are shown containing short fibril structures 7 connected between small solid PTFE node structures 8 and other small solid PTF node structures or, as shown in figure 2, large solid PTF node structures 5. The smaller pore size distributions are found within the larger pore size distribution in a random manner forming a bi-pore mosaic overall structure. As is shown in FIG. 2, a cross-section through the material displays first areas of the smaller pore size distribution and second areas distinct from the smaller pore size areas, the second areas being larger, according to the larger pore size distribution. The ratio of the first and second areas (each area measured in μm²) is preferably selected from the range of 1:5 to 1:1.

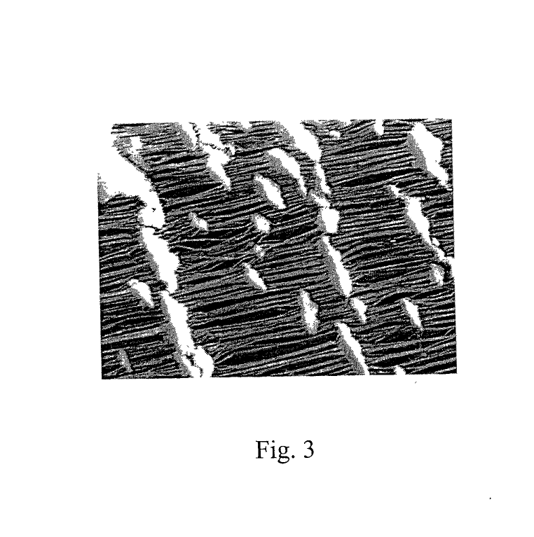

FIG. 3 is a scanning electron micrograph (SEM) of the novel structure of the preferred invention at 500×. The SEM shows the two distinct pore size distributions forming a mosaic pore structure advantageous for the invention.

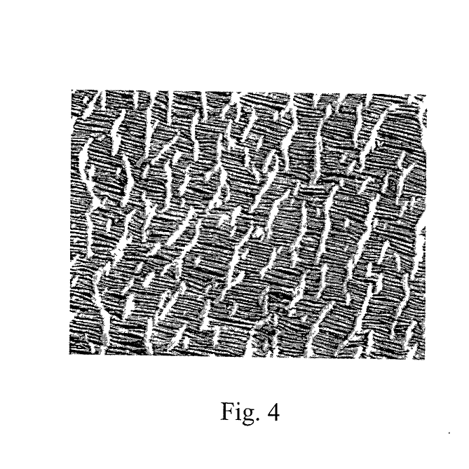

FIG. 4 is a scanning electron micrograph (SEM) of the novel structure of the preferred invention at 100×. The SEM depicts more closely the two distinct pore size distributions forming a mosaic pore structure advantageous for the invention.

The preferred invention is made in the following manner: Two PTFE resins are chosen based on the following properties. (1) A resin that expands to exhibit a relatively small pore size distribution of about 5 microns. (2) A resin that expands to exhibit a relatively large pore size distribution of about 30 microns. The resins are mixed homogenously to about a 1:1 ratio and then blended with a lubricant. The resultant paste is formed into a billet with medium pressure in a pelletizer apparatus. The billet is extruded into a tube. The resultant extruded PTFE tube is then expanded with heat to make the ePTFE structure. The resultant ePTFE tube is reinforced with an outer FEP filament wrap configured into a double helix structure. The reinforced tube is heat treated to fuse the FEP filament to the outer portion of the ePTFE tube.

In the afore-mentioned general description of the preferred embodiment, the ratio of 1:1 of the two resins can be varied in certain ranges, preferably the weight ratio can be varied in the range from 0,5:1 to 2:1, most preferably in the range from 0,75:1 to 1,25:1. Furthermore, the resins can be selected to produce other pore sizes, the most preferred ranges being stated above.

The resulting ePTFE tube exhibits the following properties: The inner wall and surface structure of the ePTFE tube exhibits a mosaic bi-pore structure of fibrils and nodes. The novel bi-pore mosaic ePTFE tube is a structure exhibiting two distinct pore size distributions found to be randomly interspaced one within the other.

### EXAMPLE I

Two polytetrafluoroethylene (PTFE) resins are selected according to their expansion characteristics as follows:

(1) A high molecular weight grade of resin (about 3 million Daltons) is selected to select for small pore sizes of about 5 microns.

(2) A low molecular weight grade of resin (about 1 million Daltons) is selected to select for large pore sizes of about 30 microns. The resins are weighed to make a ratio of about 50/50 by weight and are simultaneously blended with a lubricant until thoroughly mixed and coated with lubricant. The resultant resin paste is then made into a billet per standard practice with a billet making apparatus called a pelletizer. The billet is then warmed to about 35° C. and is inserted into a ram extruder. Forcing the PTFE billet through a die with high-pressure forms a PTFE tube. The tube is then expanded in a linear manner at about the melt point of the PTFE of about 350° C. The resultant expanded PTFE (ePTFE) tube is then cut to various lengths. The tubes are reinforced with FEP helix wrapping by inserting a precision stainless tube into the ePTFE tube and then wrapping the FEP onto the ePTFE tube. The FEP wrapping is secured to the underlying ePTFE tube by heating the assembly in an oven at or near the melting point of the FEP.

The resulting ePTFE tubes are examined and show the following characteristics:

(1) a fibril and node structure containing two distinct pore size distributions wherein one is found within another; and

(2) A very flexible tube showing excellent resistance to kinking upon bending at 180 degrees.

1. An article of expanded PTFE exhibiting a fibril and node structure containing two or more distinct pore sizes distributions, one within another, wherein one pore size distribution comprises smaller pore sizes than another pore size distribution and the smaller pore size distribution is found within the larger pore size distributions, for an application as vascular graft, cardio vascular patch, cardio vascular suture, or stent cover.

2. An article as described in claim 1, wherein the smaller pore sizes are in the range of 2 to 15 microns and the pores of the larger pore size distribution are in the range of 20 to 50 microns.

3. An article as described in claim 2, wherein the smaller pore sizes are in the range of 3 to 8 microns and the pores of the larger pore size distribution are in the range from 25 to 40 microns.

4. An article as described in one of the preceding claims, wherein the smaller sizes are in the range from 4 to 6 microns and the pores for the larger pore size distribution are in the range from 25 to 35 microns.

5. An article as described in one of the preceding the claims, wherein the smaller pore sizes are around 5 microns and the pores for the larger pore size distribution are around 30 microns.

6. An article described in one of the preceding claims, that is configured into a tube.

7. An article as described in claim 6, that is configured into a reinforced tube.

8. An article as described in one of the preceding claims, that is configured into a sheet.

9. An article described in claim 8, that is configured into a reinforced sheet.

10. A method for producing a vascular graft, cardio vascular patch, cardio vascular suture, or stent cover from expanded PTFE, said method comprising the steps of:
selecting a first resin that expands to exhibit a relatively small pore size distribution,
selecting a second resin that expands to exhibit a relatively large pore size distribution,
mixing the first and second resins and, if any, further resins, homogeneously and blending them with a lubricant,
forming the such obtained blend into a billet,
extruding the billet into a tube or sheet, and
expanding the extruded PTFE tube or sheet and heating it.

11. The method according to claim 10, wherein the small pore size is in the range from 2 to 15 microns and the large pore size in the range from 20 to 50 microns.

12. The method according to claim 10 or 11, wherein the small pore size is in the range from 3 to 8 microns and the large pore size is in the range from 25 to 40 microns.

13. The method according to one of the claims 10 to 12, wherein the small pore size is in the range from 4 to 6 microns and the large pore size is in the range from 25 to 35 microns.

14. The method according to one of the claims 10 to 13, wherein the small pore size is around 5 microns and the large pore size is around 30 microns.
